(19) United States
(12) Patent Application Publication
(10) Pub. No.: US 2004/0103771 A1
(43) Pub. Date: Jun. 3, 2004

(54) Workpiece fixture for blind cutting machine

(75) Inventor: Jung-Kuei Lin, Hsinchu (TW)

Correspondence Address: BACON & THOMAS, PLLC, 625 SLATERS LANE, FOURTH FLOOR, ALEXANDRIA, VA, 22314

(73) Assignees: INDUSTRIAL TECHNOLOGY RESEARCH INSTITUTE, HSINCHU (TW); NIEN MADE ENTERPRISE CO., LTD., TAICHUNG (TW)

(21) Appl. No.: 10/378,848

(22) Filed: Mar. 5, 2003

(30) Foreign Application Priority Data
Nov. 29, 2002 (TW) 91219280

(51) Int. Cl. B26D 5/42

(52) U.S. Cl. 83/386; 83/485

(57) ABSTRACT

An automatic workpiece fixture is installed in a blind cutting machine having a cutter unit driven by a power drive to move reciprocally for cutting a blind, and is adapted to be driven by the power drive to hold down the blind in a cutting procedure of the cutter unit. The automatic workpiece fixture includes a retainer connected to the cutter unit of the blind cutting machine for synchronous movement with the cutter unit, a push rod coupled to the retainer and held by a predetermined pressure from the retainer for movement with the retainer, and a holding down block fixedly fastened to one end of the push rod and adapted to hold down the blind when being cut.

### BACKGROUND OF THE INVENTION

1. Field of the Invention

The present invention relates generally to a blind cutting machine and, more specifically, to an automatic workpiece fixture for use in a blind cutting machine to hold down a blind for cutting.

2. Description of the Related Art

Blind manufacturers provide few sizes (lengths of headrail, bottom rail and slats) for each model. Distributors or upholsterers may have to cut blinds purchased from factories subject to different windows to be covered with blinds. Various blind cutting machines have been disclosed, and have appeared on the market.

When operating an old type blind cutting machine to cut a blind, the operator must hold down the blind with one hand, enabling the blind to be accurately cut. However, it is dangerous and not practical to hold down a blind in a blind cutting machine with the hand. Current blind cutting machines are commonly equipped with a workpiece fixture that is manually operated to hold down the loaded blind for cutting. FIG. 1 illustrates a manually operated workpiece fixture for this purpose. As illustrated, the workpiece fixture comprises a screw rod 1 and a holding down block 2 fixedly fastened to one end of the screw rod 1. The screw rod 1 is equipped with a hand wheel at one end remote from the holding down block 2. When a blind 3 inserted into the blind cutting machine, the operator rotates the hand wheel with the hand to move the holding down block 2 toward the blind 3, causing the holding down block 2 to hold down the blind 3 for cutting. This structure of manually operated workpiece fixture is not satisfactory in function. It takes much time and effort to move the holding down block between the clamping position and the release position. When rotating the screw rod, the operator must carefully control the pressure of the holding down block on the blind. Excessive high pressure to the blind may damage the blind. Insufficient pressure is unable to hold down the blind firmly in position for cutting. Further, the screw requires much installation space in a particular direction.

### SUMMARY OF THE INVENTION

The present invention has been accomplished under the circumstances in view. It is therefore the main object of the present invention to provide an automatic workpiece fixture for blind cutting machine, which can be driven by the power drive of the blind cutting machine to automatically hold down a blind for cutting.

It is another object of the present invention to provide an automatic workpiece fixture for blind cutting machine, which holds down the loaded blind positively in position for cutting.

It is still another object of the present invention to provide a workpiece fixture for blind cutting machine, which saves much time and labor during a blind cutting operation of the blind cutting machine.

It is still another object of the present invention to provide a workpiece fixture for blind cutting machine, which requires less installation space.

To achieve these objects of the present invention, the automatic workpiece fixture comprises a retainer connected to a cutter unit of a blind cutting machine for synchronous movement with the cutter unit in the blind cutting machine when the operator operating the cutter unit of the blind cutting machine, a push rod coupled to the retainer and held by a predetermined pressure from the retainer for movement with the retainer, and a holding down block fixedly fastened to one end of the push rod and adapted to hold down a blind arranged in the blind cutting machine for cutting.

### BRIEF DESCRIPTION OF THE DRAWINGS

FIG. 1 is a schematic drawing showing the arrangement of a manually operated workpiece fixture for use in a blind cutting machine according to the prior art.

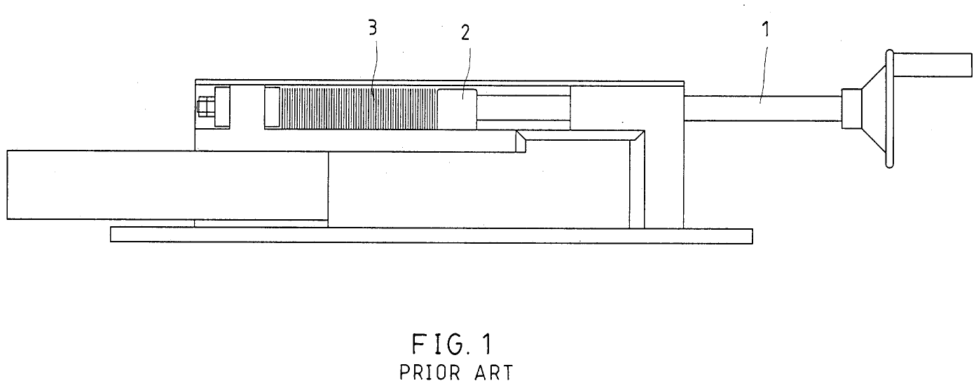

FIG. 2 is a side view of a blind cutting machine according to the present invention, showing the stand-by position of the automatic workpiece fixture.

FIG. 3 is similar to FIG. 2 but showing the holding down block touched the blind.

FIG. 4 is similar to FIG. 3 but showing the retainer touched the support.

FIG. 5 is similar to FIG. 4 but showing the slide moved to the end point of cutting.

FIG. 6 is a sectional view taken along line 6-6 of FIG. 2.

### DETAILED DESCRIPTION OF THE INVENTION

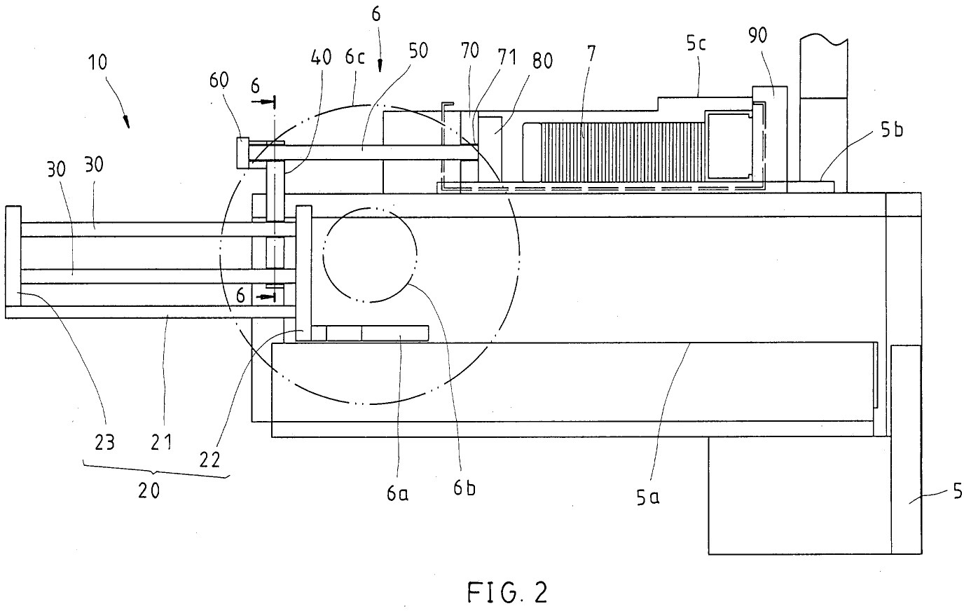

Referring to FIGS. 2˜6, a blind cutting machine is shown comprised of a machine base 5, a cutter unit 6, and an automatic workpiece fixture 10.

The machine base 5 is the main body of the blind cutting machine, comprising a working surface 5a and a cutting surface 5b arranged in parallel, and an insertion hole 5c through which the blank blind 7 to be cut is inserted and put on the cutting surface 5b for cutting.

The cutter unit 6 is installed in the machine base 5 and adapted to be reciprocated horizontally to cut off the workpiece been set in the reciprocating path of the cutter unit 6. The cutter unit 6 is constructed according to conventional techniques. According to this embodiment, the cutter unit 6 is comprised of a screw rod (not shown), a slide 6a, a motor 6b, and a cutting tool 6c, i.e. a circular saw blade. The screw rod is fastened pivotally with the working surface 5a, and rotatable by a power drive (not shown). The slide 6a is coupled to the screw rod above the working surface 5a, and moved along the screw rod between a start point of cutting and an end point of cutting on the working surface 5a upon rotary motion of the screw rod. The motor 6b is fixedly mounted on the slide 6a. The cutting tool 6c is fixedly fastened to the output shaft of the motor 6b for synchronous rotation with the output shaft of the motor 6b.

The automatic workpiece fixture 10 is controlled by the cutter unit 6 to lock or unlock the blank blind 7 been inserted into the insertion hole 5c, comprised of a sliding seat 20, two sliding rods 30, a retainer 40, a push rod 50, a bumper 60, a support 70, a holding down block 80, and a stop block 90.

The sliding seat 20 is a substantially U-shaped plate member comprising a bottom wall 21 and two upright sidewalls 22 and 23 respectively upwardly extended from two ends pf the bottom wall 21. One upright sidewall 22 is fixedly fastened to the slide 6a of the cutter unit 6, enabling the sliding seat 20 to be moved with the slide 6a.

The sliding rods 30 are fixedly connected between the upright sidewalls 22 and 23 in parallel at different elevations.

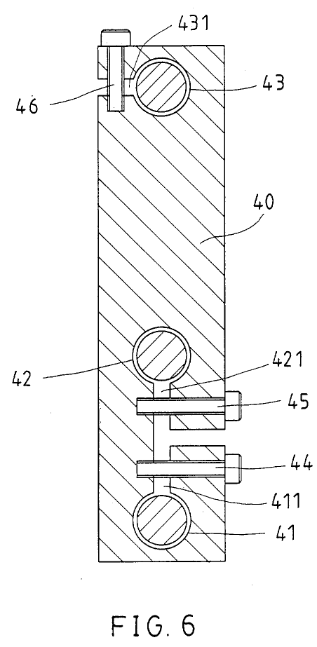

The retainer 40 is an oil-less bearing formed of a rectangular block, having three through holes 41, 42, and 43 extended in same direction (see FIG. 6), three openings 411, 421, and 431 respectively extended from the through holes 41, 42, and 43 to the periphery, and three fastening members 44, 45, and 46 respectively and alternatively moved between two positions to close/open the openings 411, 421, and 431. The first and second through holes 41 and 42 receive the sliding rods 30. When the fastening members 44 and 45 fastened up to close the respective openings 411 and 421, the through holes 41 and 42 are narrowed, thereby causing the retainer 40 to be fixedly secured to the sliding rods 30. In other words, wherein the pressure acting on the sliding rods from the retainer for holding the sliding rods can be controlled by changing the gap of the opening by tightening/loosening the fastening members, The push rod 50 is inserted through the third through hole 43 of the retainer 40 and fixedly secured thereto by fastening up the corresponding fastening member 46, that is, the pressure acting on the push rod 50 from the retainer 40 for holding the push rod 50 can be controlled by changing the gap of the opening 431 by tightening/loosening the fastening member 46. When installed, the push rod 50 is maintained in parallel to the sliding rods 30.

The bumper 60 is fixedly fastened to one end of the push rod 50 adjacent to the retainer 40. The diameter of the bumper 60 is greater than the third through hole 43 of the retainer 40, and therefore the bumper 60 cannot pass through the third through hole 43 of the retainer 40.

The support 70 is fixedly fastened to the cutting surface 5b of the machine base 5, having a through hole 71 for the passing of the push rod 50.

The clamping block 80 is fixedly fastened to one end of the push rod 50 above the cutting surface 5b, and disposed at one side of the support 70 opposite to the retainer 40 and the bumper 60. When the cutter unit 6 moved to the start point of cutting, the holding down block 80 is at the left side of the insertion hole 5c (see FIG. 2).

The stop block 90 is fixedly fastened to the cutting surface 5b at the right side of the insertion hole 5c (see FIG. 2).

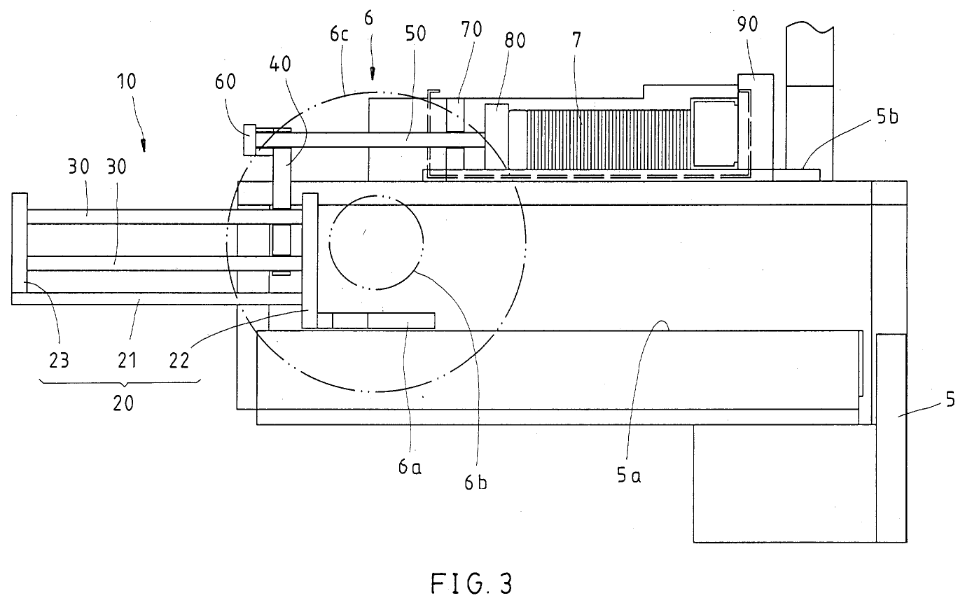

The operation of the present invention is outlined hereinafter with reference to FIGS. 2˜6, when wishing drive the cutting tool 6c to cut the blind 7 inserted into the insertion hole 5c, operate the power drive to drive the slide 6a to carry the cutting tool 6c from the start point of cutting toward the end point of cutting (see FIG. 2). When the slide 6a started to move, the slide 20, the sliding rods 30, the retainer 40, the push rod 50 and the holding down block 80 are synchronously moved with the slide 20. Because the holding down block 80 is relatively closer to the blind 7 than the cutting tool 6c when at the start point of cutting, the holding down block 80 touches the blind 7 before the cutting tool 6c. Therefore, the holding down block 80 forces the blind 7 against the stop block 90 during forward movement of the slide 6a. When the reactive force produced upon squeezing of the holding down block 80 on the blind 7 against the stop block 90 surpassed the pressure applied from the retainer 40 to the push rod 50, the holding down block 80 cannot carry the push rod 50 synchronously forwards, and the retainer 40 starts to move axially along the push rod 50 (The push rod 50 stands still, and the retainer 40 keeps moving towards the end point of cutting), thereby causing the cutting tool 6c to cut the blind 7 (see FIG. 3). At this time, the pressure applied from the holding down block 80 to the blind 7 against the stop block 90 surpasses the pressure applied from the retainer 40 to the push rod 50, and therefore the blind 7 is firmly held down in position for cutting.

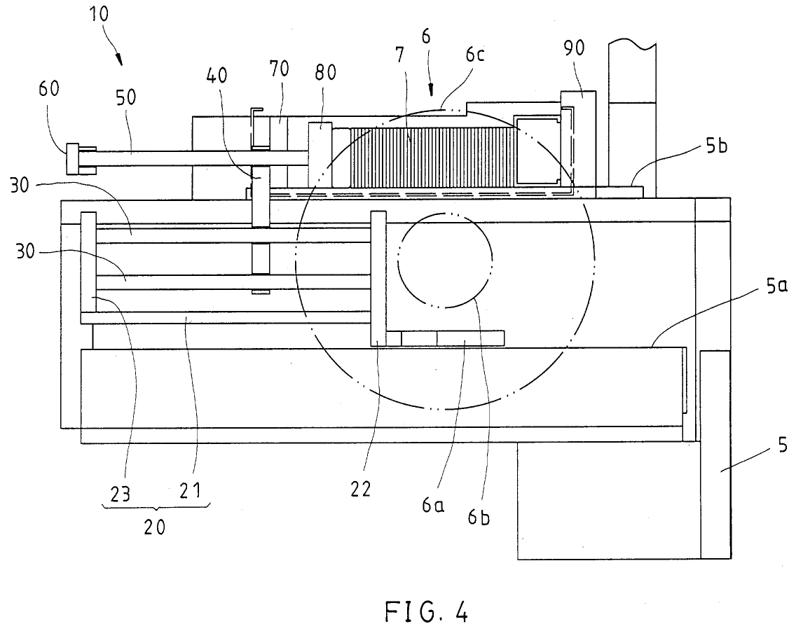

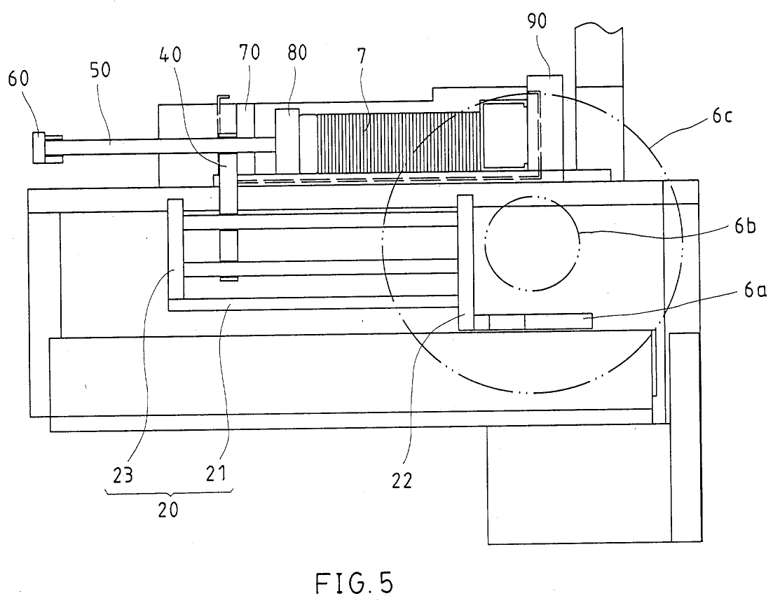

When the cutting tool 6c continuously cutting the blind 7, the push rod 50 and the holding down block 80 are maintained immovable, however the slide 6a keeps carrying the sliding seat 20, the sliding rods 30 and the retainer 40 forwards. When the retainer 40 moved with the slide 6a to the support 70 (see FIG. 4), the retainer 40 is stopped by the support 70, and the sliding rods 30 are continuously moved with the sliding seat 20 and the slide 6a forwards relative to the retainer 40. Because the lengths of the push rod 50 and the sliding rods 30 are greater than the moving distance of the slide 6a between the start point of cutting and the end point of cutting, the upright sidewall 23 of the sliding seat 20 does not touch the retainer 40 when the slide 6a moved to the end point of cutting (see FIG. 5). At this time, the blind 7 is well cut.

Further, when the slide 6a moved to the end point of cutting, the power drive moves the slide 6a in the reversed direction (i.e., the power drive is reversed to move the slide 6a from the end point of cutting toward the start point of cutting), and the sliding seat 20, the sliding rod 30, the push rod 50 and the holding down block 80 are moved with the slide 6a toward the start point of cutting. When the holding down block 80 moved to the support 70 and stopped, the slide 6a is continuously moved to carry the sliding seat 20, the sliding rods 30 and the retainer 40 toward the start point of cutting. When the retainer 40 moved to the bumper 60 and stopped, the slide 6a is continuously moved to carry the sliding seat 20 and the sliding rods 30 toward the start point of cutting. The upright sidewall 22 of the sliding seat 20 does not touch the retainer 40 when the cutting tool 6c moved with the slide 6a to the start point of cutting for a next cutting operation.

As indicated above, the blind cutting machine automatically holds down the blind for cutting and automatically releases the blind after cutting, keeping the operator from the risk of being injured by the cutting tool during cutting. Further, the power drive of the blind cutting machine itself can be used to reciprocate the workpiece fixture, so as to save installation cost and space. The invention uses the sliding rods and the push rod to achieve a two-step stroke control so that the whole device width can greatly be reduced, enabling the limited machine space to be fully utilized. Of course, a single step stroke control may be adopted. In this case, the retainer is directly connected to the slide and clamped onto the push rod, and the sliding rods and the sliding seat are eliminated.

What is claimed is:

1. A blind cutting machine adapted to cut blank blinds, comprising:
a machine base;
a cutter unit mounted in said machine base and adapted to be reciprocated by a power drive to cut a blind inserted into said machine base; and
an automatic workpiece fixture adapted to be driven by said power drive to hold down the blind in a cutting procedure of said cutter unit.

2. The blind cutting machine as claimed in claim 1, wherein said automatic workpiece fixture comprising a retainer connected to said cutter unit for synchronous movement, a push rod coupled to said retainer and held by a predetermined pressure from said retainer, and a holding down block fixedly fastened to one end of said push rod and adapted to hold down the blind for cutting by said cutter unit at a pressure not greater than the pressure applied by said retainer to said push rod.

3. An automatic workpiece fixture installed in a blind cutting machine having a cutter unit driven by a power drive to move reciprocally for cutting a blind, and adapted to be driven by the power drive to hold down the blind in a cutting procedure of said cutter unit, said automatic workpiece fixture comprising:
a retainer connected to said cutter unit for synchronous movement with the cutter unit, and
a push rod coupled to said retainer and held by a predetermined pressure from said retainer for movement with said retainer to hold down the blind at one end thereof.

4. The automatic workpiece fixture as claimed in claim 3, further comprising a holding down block fixedly fastened to the one end of said push rod for movement with said push rod to hold down the blind.

5. The automatic workpiece fixture as claimed in claim 3, further comprising a sliding seat having a bottom wall, and first and second upright sidewalls respectively perpendicularly extended from two ends of said bottom wall, said first upright sidewall being fixedly fastened to the cutter unit of said blind cutting machine, and at least one sliding rod connected between the first and second upright sidewalls of said sliding seat in parallel to said push rod and held in position by a predetermined pressure from said retainer.

6. The automatic workpiece fixture as claimed in claim 3, wherein said retainer is an oil-less bearing formed of a rectangular block, having a through hole adapted to receive said push rod, and an opening extended from said through hole at one side to the periphery of said retainer, wherein the pressure from the retainer for holding the push rod can be controlled by changing the gap of the opening.

7. The automatic workpiece fixture as claimed in claim 6, wherein said retainer further comprises a fastening member inserted through the opening from the periphery of the retainer for changing the gap of the opening.

8. The automatic workpiece fixture as claimed in claim 3, further comprising a bumper fixed at the other end of the push rod for preventing disengagement of the push rod from the retainer by an axial movement thereof.

9. The automatic workpiece fixture as claimed in claim 3, further comprising a support fixedly fastened to the blind cutting machine and adapted to support said push rod and to limit the moving distance of said retainer, said support having a through hole, which receives said push rod.
